(19) United States
(12) Patent Application Publication
(10) Pub. No.: US 2002/0080865 A1
(43) Pub. Date: Jun. 27, 2002

(54) Bidirectional signal repeater

(76) Inventor: Ishai Schwarzband, Or Yehuda (IL)

Correspondence Address: Eitan, Pearl, Latzer, & Cohen-Zedek, One Crystal Park, Suite 210, 2011 Crystal Drive, Arlington, VA, 22202-3709, US

(21) Appl. No.: 09/993,885

(22) Filed: Nov. 27, 2001

Related U.S. Application Data
(60) Provisional application No. 60/256,334, filed on Dec. 19, 2000.

(51) Int. Cl. H04B 3/36; H04B 7/17; H04B 17/02; H04L 25/20

(52) U.S. Cl. 375/211; 370/291

(57) ABSTRACT

A circuit having a hybrid to convert a bi-directional signal into an input signal and an output signal A signal subtractor to receive the input signal and subtract therefrom an estimated echo signal produced by an echo estimation unit which may derive the estimated echo signal from the output signal.

### CROSS-REFERENCE TO RELATED APPLICATIONS

This application claims the benefit of U.S. Provisional Patent Application Ser. No. 60/256,334, filed Dec. 19, 2000, incorporated herein by reference in its entirety.

### FIELD OF THE INVENTION

The present invention relates generally to the field of communications. More specifically, the present invention relates to a repeater for bidirectional transmission systems via conductive wire or cable media, for example asymmetric transmission systems such as ADSL.

### BACKGROUND

Degradation of signal-to-noise ratio (SNR) of a signal carried by long transmission lines, especially in high data rate signal lines, is one factor limiting the transmission distance and data transmission rates on these lines. In order to improve the SNR of these signals over long distances, and accordingly to augment the transmission distance and/or data rate, signal repeaters may be placed at intervals along the line.

As shown in FIG. 1, a repeater of the prior art may be constructed using two hybrids, 100U and 100D, one on each side of the repeater. Hybrid 100U, on the left side of the figure may be connected, either directly or indirectly, may be connected to a central office, and for purposes of this disclosure the left side may be designated the “Upstream Side.” Conversely, hybrid 100D, on the right side of FIG. 1, either directly or indirectly, may be connected to a subscriber or user, and for purposes of this disclosure the right side may be designated the “Downstream Side.” Each hybrid 100 may split a bi directional line into two separate unidirectional lines. That is, it may convert a bi-direction signal into two unidirectional signals, an upstream signal and a downstream signal. Conversely, each hybrid 100 may convert two unidirectional lines, an upstream line and a downstream line into a bidirectional line. The signal on each unidirectional line may be amplified by amplifiers 400D and 400U, which may result in an improved SNR in each direction. A problem with the use of a hybrid is a phenomena called an “echo”, which results from a partial leakage of the signal of one direction to the signal of opposite direction. The echo phenomena may not only distort the signals in each direction but may also cause oscillations in the repeater.

Echo cancellation or reduction is provided in repeaters of the prior art using analog to digital converters (“ADC”) 200D and 200U, where the upstream signal and the down stream signal may each be sampled, and filtered version of each may be used to reduce the echo in the other. Digital filters 600D and 600U are used to modify a sampled unidirectional signal such that it is suitable to be subtracted from and to reduce the echo in the other sampled unidirectional signal. Controller 700 may coordinate the coefficients or transform functions of each digital filter 600. Digital amplifiers 400D and 400U may amplify a sampled signal once the signal's echo component has been reduced.

Echo reduction according to the prior art requires very high sampling rates and dynamic range both in acquisition and processing (15 bit) Sampling rates twice as high as the highest data rate of either unidirectional signal may be required.

### SUMMARY OF THE INVENTION

As part of the present invention an echo reduction circuit has a hybrid to convert a bi-directional signal into an input signal and an output signal. A signal subtractor may receive the input signal and subtract therefrom an estimated echo signal produced by an echo estimation unit adapted to derive the estimated echo signal from the output signal.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram illustrating a repeater with an echo reduction circuit according to the prior art.

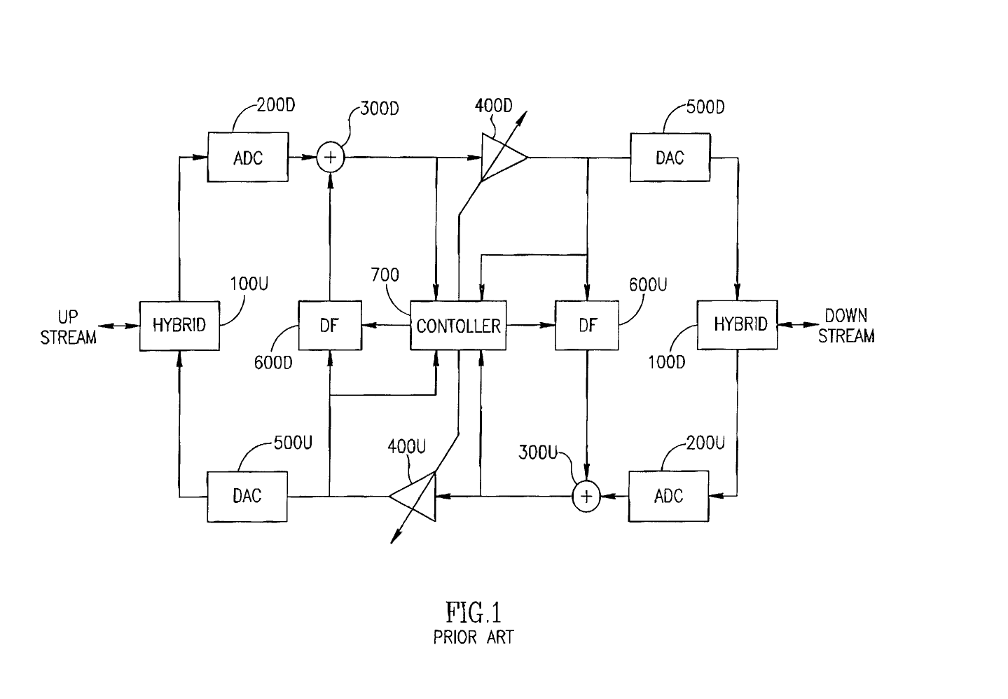

FIG. 2 is a diagram illustrating a repeater with an echo reduction circuit according to the present invention; and

FIG. 3 is a diagram illustrating an alternate configuration for a portion of the an echo reduction circuit according to the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

As part of the present invention an echo reduction circuit may have a hybrid to convert a bi-directional signal into an input signal and an output signal. A signal subtractor may receive the input signal and may subtract therefrom an estimated echo signal produced by an echo estimation unit adapted to derive the estimated echo signal from the output signal.

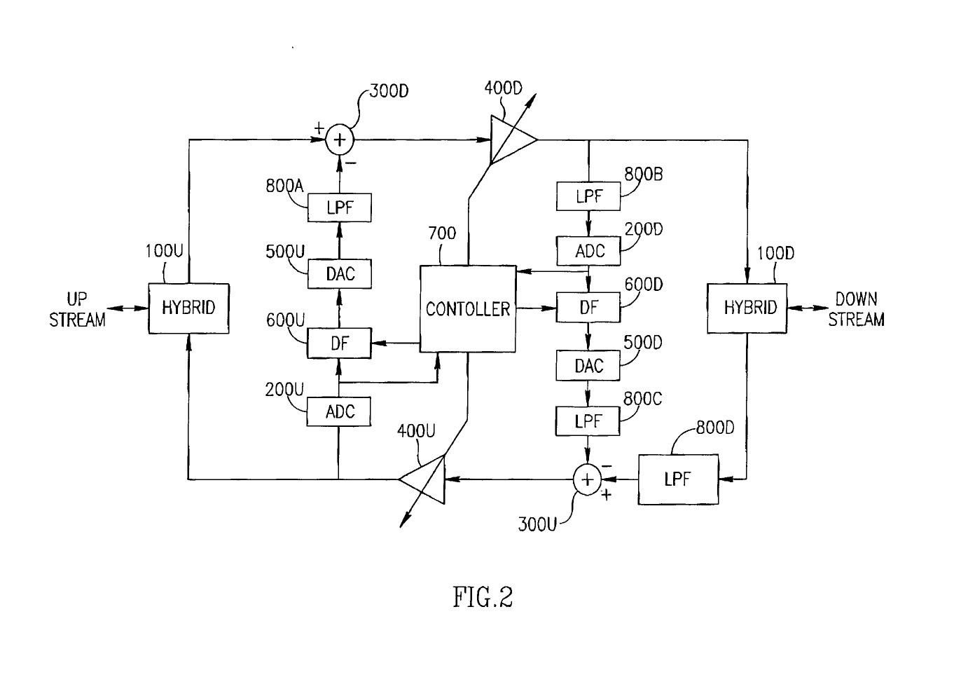

Turning now to FIG. 2, there is shown a repeater having an echo cancellation circuit according to the present invention. The repeater has hybrids 100U and 100D. Hybrid 100U, of the left of the figure, may be connected, either directly or indirectly, to a central office, and may thus be considered to be on the upstream side of the repeater. Hybrid 100D, on the right side of the figure, may be connected, either directly or indirectly, to a user or subscriber of service provided through the central office, and may thus be considered to be on the downstream side of the repeater.

Each hybrid may be connected to a line carrying a bidirectional signal. A signal coming into hybrid 100U from an upstream source, such a central office, may be split into a unidirectional line carrying what may be termed an input signal. That is, a signal coming into the repeater from an upstream source may be considered an input signal relative to hybrid 100U. The same signal, or any signal derived therefrom, which may pass through hybrid 100D, may be considered an output signal in relation to hybrid 100D. Conversely, a signal entering the repeater through hybrid 100D, from a downstream source, by be considered an input signal in relation to hybrid 100D, and any signals derived therefrom may be considered an output signal relative to hybrid 100U. In certain communication systems, for example ADSL, an upstream signal is of relatively lower bandwidth than the down stream signal.

An upstream signal entering hybrid 100U may follow a path through subtractor 300D, amplifier 400D and through hybrid 100D. A down stream signal entering hybrid 100D may follow a path through a low pass filter (“LPF”) 800D, subtracter 300U, amplifier 400U, and out hybrid 100U.

Due to leakage in either or both of the hybrids, each hybrid's input signal may contain a component of its output signal. That is, a unidirectional line carrying a hybrid's input signal may also be carrying a component of that hybrid's output signal. The output signal component may be referred to as an echo.

Depending on whether an input signal originated on the downstream side or the upstream side of the repeater, the input signal, along with its echo, may enter the positive terminal of either subtractor 300D or subtractor 300U.

The echo component of each signal may be reduced by applying to the negative terminal of a subtractor, 300D or 300U, a signal approximating or estimating the echo component entering the subtractor's positive terminal. The estimated echo signal may be produced by an echo estimation unit. One echo estimation unit may be provided for each input signal. That is, there may be one echo estimation unit for a signal entering hybrid 100U and one echo estimation unit for a signal entering hybrid 100D.

The echo estimation unit for the input signal entering the repeater through hybrid 100U may have an analog to digital converter 200U, a digital filter 600U, a digital to analog converter 500U, and a low pass filter 800A. According to the present invention, the analog to digital converter 200U may sample the output signal heading towards hybrid 100U, the sampled output of the ADC 200U may be filtered to by the digital filter 600U such that the output of the digital filter 600U approximates the echo component in the hybrid's 100U input signal, and DAC 500U may convert the digital filter's 500U output to an analog signal which is filtered by a low pass filter 800A. The output of the low pass filter 800A may be considered the estimated echo signal entering subtractor 300D.

The digital filter 600U has transform characteristics which are at least partially related to coefficients of the digital filter 600U. The coefficients may be controlled, regulated, adjusted or changed by a control circuit 700. The control circuit 700 may get samples representative of the output signal heading out of hybrid 100U from the ADC 200U. The controller 700 may also get samples representative of the output signal leaving hybrid 100D from ADC 200D. The controller 700 may analyze the samples to determine certain parameters of each signal and may modify the coefficients of the digital filter 600U such that the output of the digital filter 600U resembles the echo component attributable to the leakage through the hybrid 100U. Besides regulating the digital filter's 600U coefficients, the control circuit 700 may control the gain of amplifier 400D. Digital sampling and digital signal processing are known, and various method of determining a suitable set of digital filter coefficients and gain values are applicable to the present invention. One method may include performing Fourier transforms to determine the frequency and amplitude of the echo component in the relevant signal and then adjusting the digital filter to convert the signal to be subtracted into a mirror or the echo component. The control circuit 700 and the digital filters 600U may be implemented either in the same device (DSP) or in separate devices.

The downstream side of the repeater of FIG. 2 partially mirrors the upstream side. That is, the echo estimation unit for the signal entering subtractor 300U may also contain an ADC 200D, a digital filter 600D, a DAC 500C, and a control circuit 700. The control circuit 700 and the digital filter 600D may be implemented either in the same device (DSP) or in separate devices.

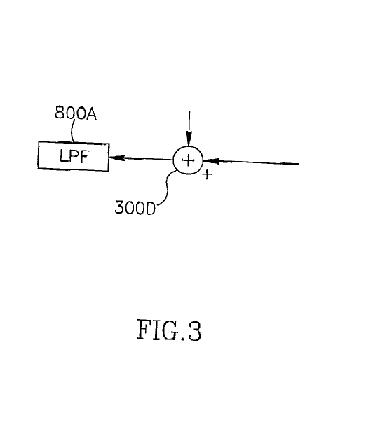

The downstream side of the repeater in FIG. 2 exemplifies an implementation of the present invention suitable for an asymmetric system such as ADSL, where the upstream signal is of a relatively lower bandwidth than the downstream signal. Given that for such a repeater only the lower frequencies for an upstream signal are relevant, a series of low pass filters 800B and 800D may be used. FIG. 3 shows an alternate position for filter 800D.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A circuit comprising a hybrid adapted to convert a bidirectional signal into an input signal and an output signal; and a signal subtractor adapted to receive said input signal and to subtract therefrom an estimated echo signal produced by an echo estimation unit adapted to derive said estimated echo signal from said output signal.

2. The circuit according to claim 1, wherein the echo estimation unit is comprised of an analog to digital converter, a digital filter and a digital to analog converter.

3. The circuit according to claim 2, further comprising a controller adapted to monitor said output signal and to regulate the transform characteristics of said digital filter as a function of one or more of said output signal's parameters.

4. The circuit according to claim 3, wherein the controller is adapted to regulate said digital filter such that said filter is adapted to transform a sampled version of said output signal into a sampled version of said estimated echo signal.

5. The circuit according to claim 4, further comprising a low pass filter between said digital to analog converter and said subtractor.

6. The circuit according to claim 1, further comprising a second hybrid, a second subtractor, and a second echo estimation unit adapted to derive a second estimated echo signal from an output signal of said second hybrid.

7. The circuit according to claim 6, wherein said second echo estimation unit is comprised of a second digital filter operatively connected to said controller.

8. The circuit according to claim 7, wherein said controller is adapted to regulate said second digital filter's transform characteristics such that said second digital filter is adapted to transform a sampled version of said second output signal into a sampled version of said second estimated echo signal.

9. A system for repeating a digital signal, comprising a connector adapted to connect to a twisted paid of wires; and a circuit operatively connected to said connector comprising a hybrid adapted to convert a bidirectional signal into an input signal and an output signal; and a signal subtractor adapted to receive said input signal and to subtract therefrom an estimated echo signal produced by an echo estimation unit adapted to derive said estimated echo signal from said output signal.

10. The system according to claim 9, wherein the echo estimation unit is comprised of an analog to digital converter, a digital filter and a digital to analog converter.

11. The system according to claim 10, further comprising a controller adapted to monitor said output signal and to regulate the transform characteristics of said digital filter as a function of one or more of said output signal's parameters.

12. The system according to claim 11, wherein the controller is adapted to regulate said digital filter such that said filter is adapted to transform a sampled version of said output signal into a sampled version of said estimated echo signal.

13. The system according to claim 12, further comprising a low pass filter between said digital to analog converter and said subtractor.

14. The system according to claim 9, further comprising a second hybrid, a second subtractor, and a second echo estimation unit adapted to derive a second estimated echo signal from an output signal of said second hybrid.

15. The system according to claim 14, wherein said second echo estimation unit is composed of a second digital filter operatively connected to said controller.

16. The system according to claim 15, wherein said controller is adapted to regulate said second digital filter's transform characteristics such that said second digital filter is adapted to transform a sampled version of said second output signal into a sampled version of said second estimated echo signal.

17. A method of reducing an echo in a first signal leaving a hybrid caused by leakage from a second signal entering the hybrid, said method comprised of sampling the second signal, filtering the sampled signal, converting the sampled signal into an analog signal and subtracting the analog signal from the first signal.

18. The method according to claim 17 further comprising adjusting a transform characteristic of the digital filter such that the output of the digital filter is a sampled version of an estimated echo signal.

19. The method according to claim 18, further deriving the transform characteristic from a parameter of the second signal.

20. The method according to claim 18, further comprising low pass filtering the output of a digital to analog converter.
